(19) United States
(12) Patent Application Publication
(10) Pub. No.: US 2024/0054371 A1
(43) Pub. Date: Feb. 15, 2024

(54) SYSTEMS AND METHODS FOR INCORPORATING SUPPLEMENTAL SHAPE INFORMATION IN A LINEAR DISCRIMINANT ANALYSIS

(71) Applicant: Wells Fargo Bank, N.A., San Francisco, CA (US)

(72) Inventors: Geng DENG, McLean, VA (US); Yaoguo XIE, Charlotte, NC (US); Xindong WANG, Dayton, MD (US); Qiang FU, McLean, VA (US)

(21) Appl. No.: 18/193,367

(22) Filed: Mar. 30, 2023

Related U.S. Application Data
(60) Provisional application No. 63/370,822, filed on Aug. 9, 2022.

(51) Int. Cl. G06N 7/01; G06N 20/00

(52) U.S. Cl. CPC G06N 7/01; G06N 20/00

(57) ABSTRACT

Systems, apparatuses, methods, and computer program products are disclosed for training a lattice linear discriminant analysis (Lattice-LDA). An example method includes receiving, by communications hardware, a training dataset comprising one or more features, and selecting, by training circuitry, a set of shape constraints, the set of shape constraints including a shape constraint for each feature in the training dataset. The example method further includes training, by the training circuitry, the Lattice-LDA using the training dataset and the selected set of shape constraints, where the Lattice-LDA is generated based on an additive form of a plurality of nonlinear functions, and training the Lattice-LDA generates a shape-restricted hyperplane that defines a decision boundary separating a first class of data points in the training dataset from a second class of data points in the training dataset.

### CROSS REFERENCE TO RELATED APPLICATIONS

The present application claims the benefit of U.S. Provisional Application No. 63/370,822, filed Aug. 9, 2022, which is hereby incorporated by reference in its entirety.

### BACKGROUND

Classification is a fundamental supervised learning tool for predictive knowledge discovery. Linear discriminant analysis (LDA) is a supervised learning tool with applications in classification and dimensionality reduction. Although developed in 1936, LDA has been generalized to handle a variety of classification problems and is still a powerful tool used widely today. The traditional LDA constructs a linear hyperplane which separates two classes of data, while a more generalized discriminant analysis may employ an advanced kernel transformation to handle non-linearity.

### BRIEF SUMMARY

In machine learning, classification refers to the problem of using an object's features to identify which group or class it belongs to. The classification problem has a long history and can be traced to Fisher's LDA.

For classification problems in many areas of applied science, there frequently exist underlying shape relationships, including monotonicity and unimodality, between inputs and targets. For example, in business and econometrics, demand functions are generally monotonically decreasing in prices, cost functions are monotonically increasing and may be concave in input prices, and utility functions of risk averse agents are concave. Conventional classifiers, such as standard LDA and logistic regression, are not able to utilize this domain-specific knowledge to improve model's prediction accuracy and interpretability. Considering various types of shape information, monotonicity is the most commonly encountered and widely used in practice. Traditional classifiers, which may not accommodate the aforementioned shape information, could yield to overfitting to data and produce counter-intuitive outputs.

Motivated by the flexibility of lattice approach, example embodiments described herein introduce Lattice-LDA, a novel extension of LDA using the lattice-based discriminant hyperplane. Example embodiments of the new classifier directly support simple shape constraints such as monotonicity and convexity/concavity for unimodal input. Example embodiments also demonstrate the ability to process more complex shape constraints such as the S-shape. The approach is based on developing a nonlinear discriminant hyperplane using an additive model of 1-D lattice functions (which is essentially a piecewise linear function). Estimation of the lattice parameters may employ the Adaptive Moment Estimation (Adam) Stochastic Gradient Descent (SGD) algorithm which includes a sequential projection algorithm to map to solution to shape constrained feasible regions. The lattice-based model is a nonparametric approach, where the lattice itself is fully defined by the lattice grid and the values at the grid. The shape constraint can be considered as a model regularization to improve robustness of fit.

In one example embodiment, a method is provided for training a Lattice-LDA. The method includes receiving, by communications hardware, a training dataset comprising one or more features; selecting, by training circuitry, a set of shape constraints, the set of shape constraints including a shape constraint for each feature in the training dataset; and training, by the training circuitry, the Lattice-LDA using the training dataset and the selected set of shape constraints, where the Lattice-LDA is generated based on an additive form of a plurality of nonlinear functions, and training the Lattice-LDA generates a shape-restricted hyperplane that defines a decision boundary separating a first class of data points in the training dataset from a second class of data points in the training dataset.

In another example embodiment, an apparatus is provided for training a Lattice-LDA. The apparatus includes communications hardware configured to receive a training dataset comprising one or more features; and training circuitry configured to select a set of shape constraints, the set of shape constraints including a shape constraint for each feature in the training dataset, and train the Lattice-LDA using the training dataset and the selected set of shape constraints, where the Lattice-LDA is generated based on an additive form of a plurality of nonlinear functions, and training the Lattice-LDA generates a shape-restricted hyperplane that defines a decision boundary separating a first class of data points in the training dataset from a second class of data points in the training dataset.

In another example embodiment, a computer program product is provided for training a Lattice-LDA. The computer program product comprises at least one non-transitory computer-readable storage medium storing program instructions that, when executed, may cause an apparatus to receive a training dataset comprising one or more features; select a set of shape constraints, the set of shape constraints including a shape constraint for each feature in the training dataset; and train the Lattice-LDA using the training dataset and the selected set of shape constraints, where the Lattice-LDA is generated based on an additive form of a plurality of nonlinear functions, and training the Lattice-LDA generates a shape-restricted hyperplane that defines a decision boundary separating a first class of data points in the training dataset from a second class of data points in the training dataset.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating shape information in a LDA, in accordance with some example embodiments described herein.

FIG. 2 illustrates a schematic block diagram of example circuitry embodying a device that may perform various operations in accordance with some example embodiments described herein.

FIG. 3A illustrates plots of source data, contours, and a LDA discriminant line from an example LDA analysis.

FIG. 3B illustrates two Gaussian conditional distributions corresponding to each class of an example LDA analysis.

FIG. 4A illustrates a piecewise linear function construction of r(x) (equivalent to a one-dimensional lattice).

FIG. 4B illustrates a projection of a non-monotone solution as a monotone increasing solution.

FIG. 5A illustrates an example convex increasing separating line.

FIG. 5B illustrates an example piecewise linear spline approximation \hat{r}₁(x₁) as compared to actual functional form r₁(x₁)=x₁³.

FIG. 6A illustrates an example piecewise linear spline approximation \hat{r}₁(x₁) as compared to actual function form r₁(x₁)=2x₁².

FIG. 6B illustrates an example piecewise linear spline approximation \hat{r}₂(x₂) as compared to actual function form r₂(x₂)=e^{x}^{₂}−1.

FIG. 6C illustrates an example piecewise linear spline approximation \hat{r}₃(x₃) as compared to actual function form r₃(x₃)=log(x₃)/4+2.

FIG. 7 illustrates a bar plot of each feature in the Pima example, where orange bars correspond to data labeled “test positive” (1) and blue bars correspond to data labeled “test negative” (−1).

FIG. 8 illustrates a plot of each marginal approximation function in the Pima data set example.

FIG. 9 illustrates a bar plot of each feature in the Wisconsin breast cancer example, where orange bars correspond to data labeled “malignant” (1) and blue bars correspond to data labeled “benign” (−1).

FIG. 10 illustrates a plot of each marginal approximation function in the Wisconsin breast cancer example.

FIG. 11 illustrates an example flowchart for incorporating shape information in a LDA, in accordance with some example embodiments described herein.

FIG. 12 illustrates another example flowchart for selecting a shape constraint set for a Lattice-LDA, in accordance with some example embodiments described herein.

FIG. 13 illustrates another example flowchart for training a Lattice-LDA, in accordance with some example embodiments described herein.

FIG. 14 illustrates another example flowchart for selecting a candidate knot set for a Lattice-LDA, in accordance with some example embodiments described herein.

FIG. 15 illustrates another example flowchart for classifying data points based on the trained Lattice-LDA, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “linear discriminant analysis” (LDA) refers to the method or algorithm configured to provide a solution to a classification problem by finding a linear separating hyperplane of training dataset features that separates two or more classes of a training dataset.

The term “lattice” refers to data element configured to describe a regular set of points, in the space of a training dataset, or a subspace thereof. In the Lattice-LDA approach, points of the lattice are identified with knots, points on which interpolated parametric functions are fixed. The location of points on the lattice, and subsequently the locations of the knots, may be determined by a variety of methods. In some embodiments, user input may be interpreted to fix knots to particular locations. In some embodiments, knots may be automatically evenly spaced over the domain of a training dataset. The sub-intervals defined by dividing the training dataset domain by the knots are referred to as “buckets.” The term “knot value vector” refers to a vector of the knot values described above.

The term “feature” refers to a data element configured to describe a characteristic of the training dataset. Characteristics may typically be a numerical value or a characteristic that may be converted to a numerical value (e.g., via one hot encoding or the like). A given feature may be present for all of the training dataset, or may only be present for a subset of the training dataset, in the case where the training dataset is not complete. For example, a training dataset collected to track diabetes risk in a population may have features such as age, blood pressure, body mass index, or the like.

The term “shape constraint” refers to a data element configured to describe a form of regularization applied to the Lattice-LDA model which restricts function values on the lattice to follow certain shape requirements such as monotonicity, convexity, or concavity. The Lattice-LDA model may ensure the shape constraints are satisfied by imposing restrictions on lattice function values in the optimization algorithm. Shape constraints may be imposed component-wise, or on individual features of the training dataset. For example, a training data set with four features may have a different shape constraint applied to each feature, or may have certain features with no shape constraint at all.

The term “hyperplane” refers to a data element configured to describe a set of points with dimensionality of one less than the dimensionality of the space in which the points are embedded. In LDA, a hyperplane defines the discriminant boundary between two classes of a training dataset. For example, a training dataset with two input features would exist in a two-dimensional plane, while the discriminant boundary would be defined by a one-dimensional line.

The term “shape projection algorithm” refers to a data element configured to describe a step in the optimization method of Lattice-LDA where shape constraints are imposed on the knot value vector. The constraints gi(β(i))>0 on the knot value vector β(i) are shape constraints specifying the shape of each individual feature. The shape projection algorithm is chosen for each shape constraint to impose the constraints at each step of the optimization method.

### System Architecture

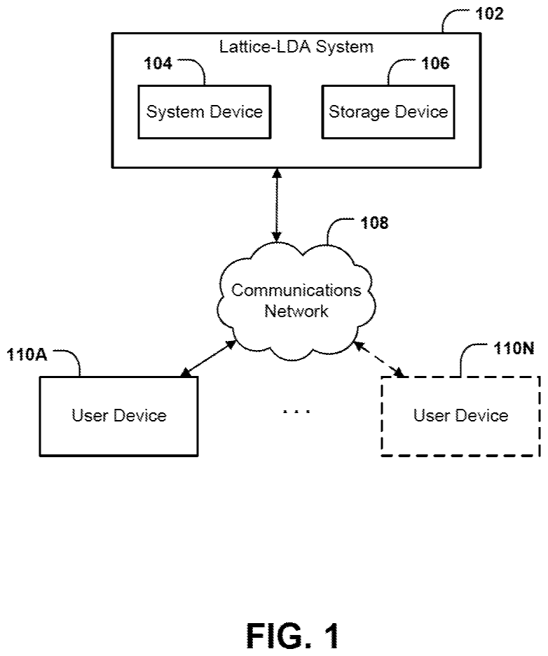

Example embodiments described herein may be implemented using any of a variety of computing devices or servers. To this end, FIG. 1 illustrates an example environment within which various embodiments may operate. As illustrated, a Lattice-LDA system 102 may include a system device 104 in communication with a storage device 106. Although system device 104 and storage device 106 are described in singular form, some embodiments may utilize more than one system device 104 and/or more than one storage device 106. Additionally, some embodiments of the Lattice-LDA system 102 may not require a storage device 106 at all. Whatever the implementation, the Lattice-LDA system 102, and its constituent system device 104 and/or storage device 106 may receive and/or transmit information via communications network 108 (e.g., the Internet) with any number of other devices, such as one or more of user device 110A through user device 110N.

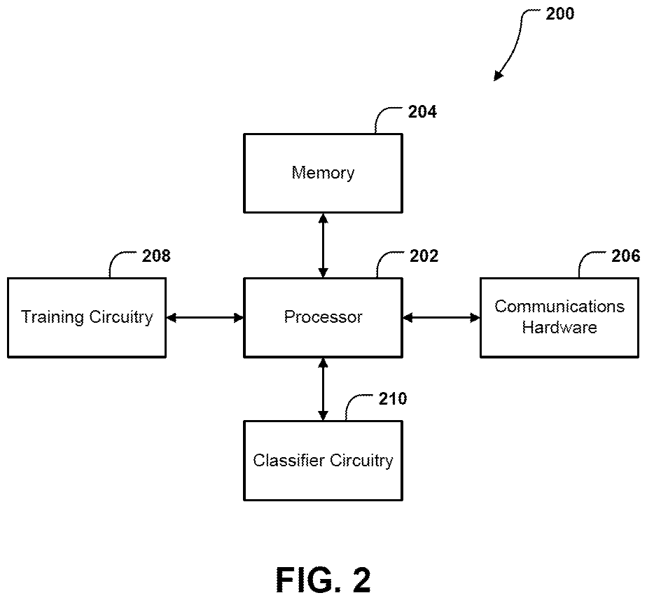

The system device 104 may be implemented as one or more servers, which may or may not be physically proximate to other components of the Lattice-LDA system 102. Furthermore, some components of system device 104 may be physically proximate to the other components of the Lattice-LDA system 102 while other components are not. The system device 104 may receive, process, generate, and transmit data, signals, and electronic information to facilitate the operations of the Lattice-LDA system 102. Particular components of system device 104 are described in greater detail below with reference to apparatus 200 in connection with FIG. 2.

The storage device 106 may comprise a distinct component from system device 104, or may comprise an element of system device 104 (e.g., memory 204, as described below in connection with FIG. 2). The storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). The storage device 106 may host the software executed to operate the Lattice-LDA system 102. The storage device 106 may store information relied upon during operation of the Lattice-LDA system 102, such as various input data that may be used by the Lattice-LDA system 102, data and documents to be analyzed using the Lattice-LDA system 102, or the like. In addition, the storage device 106 may store control signals, device characteristics, and access credentials enabling interaction between the Lattice-LDA system 102 and one or more of the user devices 110A-110N.

The one or more user devices 110A-110N may be embodied by any computing devices known in the art, such as desktop or laptop computers, tablet devices, smartphones, or the like. The one or more user devices 110A-110N need not themselves be independent devices, but may be peripheral devices communicatively coupled to other computing devices.

Although FIG. 1 illustrates an environment and implementation in which the Lattice-LDA system 102 interacts with one or more of user devices 110A-110N. In some embodiments users may directly interact with the Lattice-LDA system 102 (e.g., via communications hardware 206 of system device 104), in which case a separate user device 110 may not be utilized. Whether by way of direct interaction or via a separate user device 110, a user may communicate with, operate, control, modify, or otherwise interact with the Lattice-LDA system 102 to perform the various functions and achieve the various benefits described herein.

### Example Implementing Apparatuses

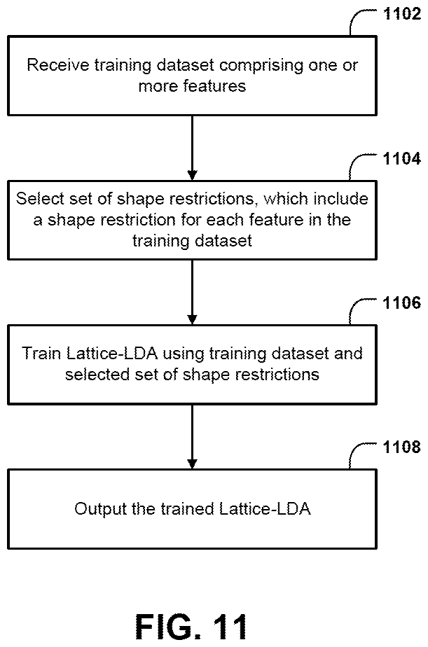

The system device 104 of the Lattice-LDA system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, training circuitry 208, and classifier circuitry 210, each of which will be described in greater detail below. While the various components are only illustrated in FIG. 2 as being connected with processor 202, it will be understood that the apparatus 200 may further comprise a bus (not expressly shown in FIG. 2) for passing information amongst any combination of the various components of the apparatus 200. The apparatus 200 may be configured to execute various operations described above in connection with FIG. 1 and below in connection with FIGS. 11-13.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may be configured to provide output to a user and, in some embodiments, to receive an indication of user input. It will be noted that some embodiments will not include such configurations, in which case user input may be received via a separate device such as one of the user devices 110A-110N (shown in FIG. 1). The communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a training circuitry 208 that trains the linear discriminator. The training circuitry 208 may utilize processor 202, memory 204, or any other hardware component included in the apparatus 200 to perform these operations, as described in connection with FIGS. 11-13 below. The training circuitry 208 may further utilize communications hardware 206 to gather data from a variety of sources (e.g., user devices 110A-110N or storage device 106, as shown in FIG. 1) or to receive data from a user, and in some embodiments may utilize processor 202 and/or memory 204 to train the Lattice-LDA. In some embodiments, the training circuitry 208 may be configured to store the trained Lattice-LDA in an associated storage, such as memory 204, storage device 106, or another storage device. In some embodiments, training circuitry 208 may access the stored lattice-LDA to perform training and/or re-training related operations.

In addition, the apparatus 200 further comprises a classifier circuitry 210 that utilizes the trained Lattice-LDA to classify data. The classifier circuitry 210 may utilize processor 202, memory 204, or any other hardware component included in the apparatus 200 to perform these operations, as described in connection with FIGS. 11-13 below. The classifier circuitry 210 may further utilize communications hardware 206 to gather data from a variety of sources (e.g., user devices 110A-110N or storage device 106, as shown in FIG. 1) or to receive data from a user, and in some embodiments may utilize processor 202 and/or memory 204 to classify data. In some embodiments, classifier circuitry 210 may be configured to access the stored, trained lattice-LDA from an associated storage, such as memory 204, storage device 106, or another storage device.

Although components of FIG. 2 are described in part using functional language, it will be understood that the particular implementations necessarily include the use of particular hardware. It should also be understood that certain of these components of FIG. 2 may include similar or common hardware. For example, the training circuitry 208 and classifier circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the training circuitry 208 and classifier circuitry 210 may leverage processor 202, memory 204, or communications hardware 206, as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), memory 204, or communications hardware 206 for enabling any functions not performed by special-purpose hardware elements. In all embodiments, however, it will be understood that the training circuitry 208 and classifier circuitry 210 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third-party circuitries. In turn, that apparatus 200 may be in remote communication with one or more of the other components described above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below.

### Standard LDA

The standard Linear Discriminant Analysis (LDA) model was first proposed to separate two classes of objects, and was later generalized to address multi-class problems. The notions and algorithms of the standard LDA are briefly introduced below.

A training data set may be denoted as a set of objects xl and corresponding labels yl (e.g., {(xl ,y1)}) and where an object index l ranges between 1 and a total number of objects N. Each object xl includes d features such that each object xl is an element of the set of real numbers (e.g., xl∈ [symbol] ^{d}). Additionally, each label yl is from an M-class set where yl is an element of a set ranging between 0 to M−1. In the conventional discriminant analysis, the density of input X of each class M is assumed to follow a multivariate Gaussian distribution N(μm, Σm), where μm is a distribution mean matrix and Σm is a covariance of the distribution matrix. More specifically, in LDA, a homoscedasticity assumption is used such that all distributions share the same covariance matrix such that the covariance matrix for a given class m Σm is equivalent to a single covariant matrix Σ. LDA thereby differs from a Quadratic Discriminant Analysis (QDA), which allows the covariance matrix Σₘ to differ by class m. LDA applies the Bayesian inference to select the optimal class label corresponding to the highest conditional probability p:

$$LDA ( x ) = arg {max}_{m} p ( y = m \vert X = x ) .$$

After the variable transformation and simplification process, the solution of the LDA classifier is linked to the Gaussian distribution parameters:

$$LDA ( x ) = arg {max}_{m} {x}^{T} {\sum }^{- 1} {μ}_{m} - \frac{1}{2} {μ}_{m}^{T} {\sum }^{- 1} {μ}_{m} + log ( {π}_{m} )$$

where πₘ is the prior probability.

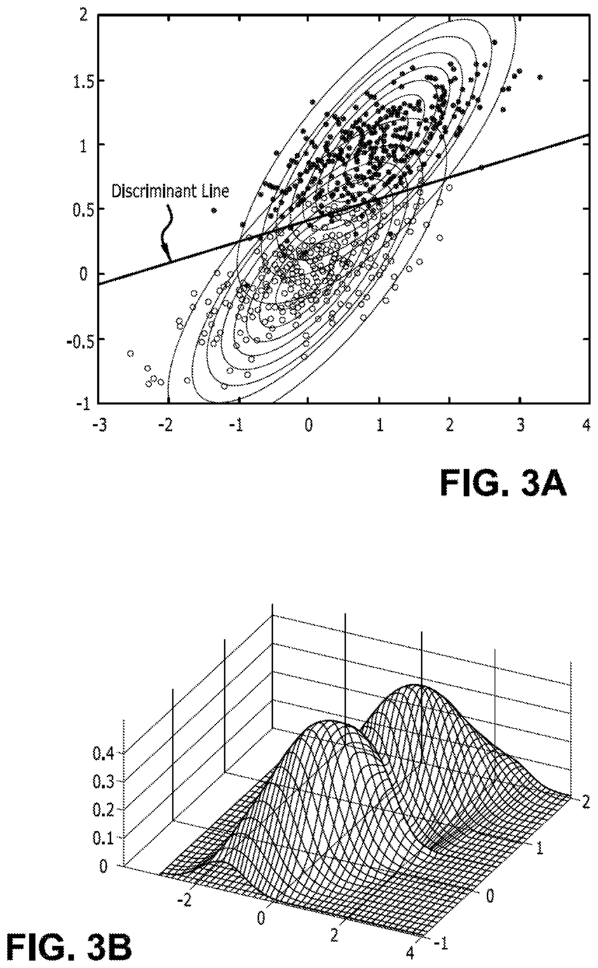

For illustration purposes, Fisher's LDA is performed using a two-class example. A label yₗ may be defined as element of a two-class set 0 and 1 (e.g., yₗ∈{0,1}), and is therefore a 2-dimensional example. Because there are two features (e.g., d=2), the class separating boundary is essentially in a linear line. FIG. 3A provides the scatter plot of the source data shown using hollow dots representing the first class and solid dots representing the second class. It also plots the corresponding contours of the conditional distribution, and the linear discriminant line generated by LDA. FIG. 3B shows two density plots of the corresponding Gaussian conditional distributions for each class. LDA may predict the label corresponding to the larger of the two densities.

In LDA, the linear discriminant boundary is defined as a linear hyperplane where x^{T}β−β₀ is equal to 0. Here, optimal estimators \hat{β} and \hat{β}₀ are defined as:

$$\hat{β} = {\sum }^{- 1} ( {μ}_{1} - {μ}_{0} )$$

$${\hat{β}}_{0} = \frac{1}{2} {β}^{T} ( {μ}_{1} + {μ}_{0} )$$

where μ₀ is the distribution mean matrix for the first class and μ₁ is the distribution mean matrix for the second class.

In Fisher's original definition, the coefficients β of the separating plane are in proportion to the solution by minimizing the ratio S(β) of the variance between the classes σ_{between} to the variance within the classes σ_{within} as shown below:

$$\hat{β} ∝ {arg min}_{β} S ( β ) : = β \frac{{σ}_{between}^{2}}{{σ}_{within}^{2}} = \frac{{( {β}^{T} ( {μ}_{1} - {μ}_{0} ) )}^{2}}{2 {w}^{T} Σ w}$$

As a result, the formula serves as a verification of the optimality of optimal estimator \hat{β}. If optimal estimator \hat{β} is optimal, the gradient of the objective function should satisfy the below equation

$${\frac{\partial S ( β )}{\partial β} \vert}_{\hat{β}} = 0.$$

### Lattice-LDA for Shape Constrained Classification

Example embodiments of the Lattice-LDA method may utilize the discriminant hyperplane as a core feature. The hyperplane may be constructed using an additive model of the 1-D lattice functions, instead of directly using a high dimensional lattice. The optimization algorithm may ensure that each of the 1-D functions satisfies the corresponding shape constraint.

Recall that in LDA, the separating hyperplane is linear:

$$f ( x ) = {x}^{T} β + {β}_{0} = {\sum }_{i = 1}^{d} {x}_{i} {β}_{i} + {β}_{0} = 0$$

where d is the number of features.

The Lattice-LDA may introduce a nonlinear function f(⋅), which is defined as an additive form of 1-D nonlinear functions rᵢ(xᵢ) of each feature xᵢ:

$$f ( x ) = {\sum }_{i = 1}^{d} {r}_{i} ( {x}_{i} ) + {β}_{0} \qquad ( 1 )$$

Each function ri(xi) is subject to a different shape constraint and, as a result, the linear combination function f(⋅) also marginally satisfies the shape constraints of feature xi. Note that, from the marginal convexity or concavity, it is not necessary to imply if the joint effect is convex or concave. In other words, the shape information regarding the interactions of features is not considered.

Five example types of shape constraints are shown, including linear, monotone increasing/decreasing, and convex/concave, as shown in Table 1. In Lattice-LDA, the model is component-wise shape-restricted, which implies each feature xᵢ satisfies one of the specific shape constraints. These five shapes are simple and fundamental types of shapes, which can be readily expanded to more complex combinations of the shapes such as convex increasing/decreasing or S-shape.

TABLE 1
Example shape constraints

| Shape number | Shape type | Shape label |
|---|---|---|
| 1 | Linear | 1 |
| 2 | Monotone increasing | in |
| 3 | Monotone decreasing | de |
| 4 | Convex | cvx |
| 5 | Concave | ccv |

The following subsections first disclose how to construct the 1-D function rᵢ(xᵢ) by applying the lattice transformation, formulate the Lattice-LDA optimization problem, and then solve it using the Adam SGD method.

### Lattice Transformation

The concept of lattice transformation is related to lattice regression, which essentially interpolates a parametric function on a regular grid of knots. When the function values on the grid knots are defined, the function in the lattice cell is calculated via weighted average of the vertex values of the cell. The lattice transformation maps the original data to a higher dimensional sparse matrix of the weights. Instead of processing the source data, the transformed weight matrix effectively becomes the new model input.

The lattice transformation is designed in generic high-dimensional problems, however, a high-dimensional lattice of (x1, x2, . . . , xd) is expensive to construct. To simplify the approach, a 1-D lattice transformation may be applied to each function ri(xi). Suppose that there are Ki knots in the xi dimension, where the knots are defined as

X_{1,i}≤X_{2,i}≤ . . . ≤X_{K}_{ᵢ}_{,i}

X_{1,i} and X_{K}_{ᵢ}_{,i} represent the minimum and maximum bounds of the domain of xᵢ. The location of the knots is customizable but is typically set as (equally spaced) quantiles of the data and unchanged throughout the model estimation. As a result, each 1-D lattice of xᵢ may be completely defined using Kᵢ knot values or Kᵢ parameters.

### Piecewise Linear Approximation of r(x)

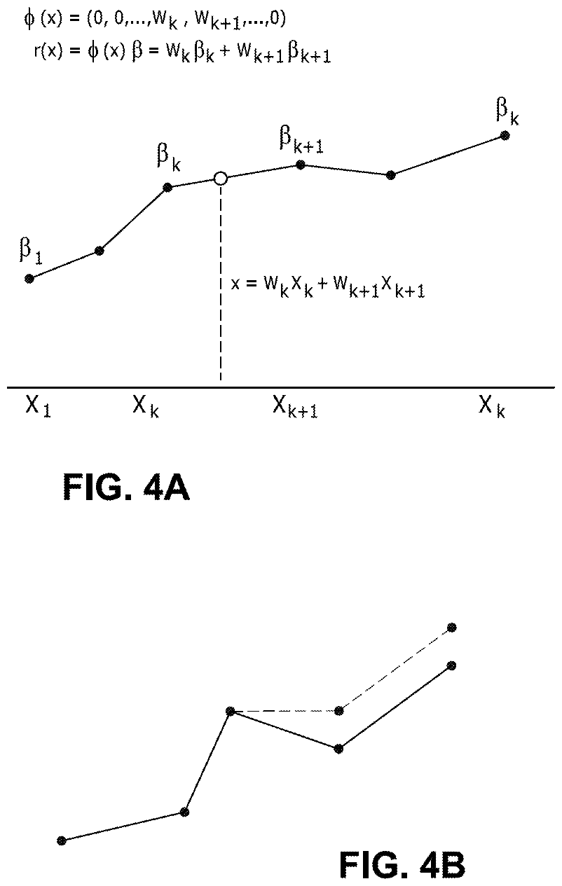

The 1-D lattice is essentially a piecewise linear function. Without loss of generality, the subscript i is omitted in this subsection, reducing the function form to r(x). This section discloses how to approximate the function r(x) using an interpolation of look-up table values on the knots. FIG. 4A provides an illustration of the piecewise linear, or 1-D lattice approximation.

The pre-specified K knots X₁, X₂, . . . , X_{K} define K−1 buckets in the entire domain of x. Suppose x is a data point in one bucket [Xₖ, Xₖ+1), it can be expressed as the weighted average of the precedent and subsequent knots:

x=wₖXₖ+wₖ₊₁Xₖ₊₁

where the linear weights wₖ are computed as:

$${w}_{k} = \frac{{X}_{k + 1} - x}{{X}_{k + 1} - {X}_{k}} and {w}_{k + 1} = 1 - {w}_{k} .$$

Let a parameter vector β be the knot values of the piecewise linear function, or βₖ=r(Xₖ). The values of the parameter β regulate the shape of the piecewise linear function. The function value of r(x) is therefore the weighted average of the knot values:

r(x)=wₖβₖ+wₖ₊₁βₖ₊₁

In order for the formula to be consistent across all buckets, we introduce a weight vector ϕ(x) of length K for any given x, and include zero weights in the other buckets:

ϕ(x)=(0, 0, . . . , wₖ, wₖ₊₁, 0, . . . , 0)

such that:

x=ϕ(x)^{T}(X₁, X₂, . . . , X_{K})

and define the piecewise function r(x) of the entire domain as:

r(x)=ϕ(x)^{T}β

The weight vector ϕ(x) is the lattice transformation or mapping function.

Note that the vector β defines the look-up table values on each knots r(Xᵢ)=βᵢ. To make the function r(x) satisfy domain-knowledge shape constraints, the values of β may be altered. For example, for a monotone increasing piecewise linear function r(x), β needs to be monotone increasing:

βₖ≤βₖ₊₁, k=1, 2, . . . , K−1.

The values in β can be altered in a similar way such that the vector meets the more complex shape constraints, including convex or concave shapes. Using the knot values β to control the shape of the function is a feature of the lattice transformation.

### The New Lattice-LDA Model

Each shape-restricted 1-D lattice is formulated as

rᵢ(xᵢ)=ϕᵢ(xᵢ)^{T}β⁽ⁱ⁾,

where β⁽ⁱ⁾ are the vectors of knot values defined above (subscript i has been dropped).

Without loss of generality, the first d₁ indexes are assumed to be linear type shapes, which do not require to a piecewise linear formulation:

rᵢ(xᵢ)=xᵢβ⁽ⁱ⁾, or ϕ(xᵢ)=xᵢ, i=1, 2, . . . , d₁.

The remaining terms rᵢ(xᵢ), i=d₁+1, . . . , d are shape-constrained piecewise linear functions. Therefore, when merging all components together, it results in the nonlinear hyperplane defined by:

0=f(x, β, β₀)=ϕ(x)^{T}β+β₀, s.t. gᵢ(β⁽ⁱ⁾)≥0, i=d₁+1, . . . , d,

where ϕ(x) concatenates all components of ϕᵢ(xᵢ), i=1, 2, . . . , d. gᵢ(⋅)≥0 is a conceptual form of constraint that requires each knot value vector β⁽ⁱ⁾ to satisfy the corresponding shape constraints.

After applying the lattice transformation on input x to ϕ(x), which is a matrix of weights, the original input with d dimensions is transformed to a much larger dimension: d1+Σdi=d1+1Ki number of covariates. Given the hyperplane defined by {x|f(x, β, β0)=0}, the Lattice-LDA's objective function is the variance ratio function S(β), the same as the standard LDA. Lattice-LDA requires additional shape constraints gi(β(i))≥0, i=d1+1, . . . , d.

The optimization problem setup of the new shape-constrained Lattice-LDA may then be formulated as a new constrained optimization problem

$$\hat{β} ∝ {arg min}_{β} S ( β )$$

subject to gᵢ(β⁽ⁱ⁾)≥0, i=d₁+1, . . . , d.

### Adam SGD Method with Stepwise Projection

In this subsection, an example embodiment utilizing the Adam SGD method with stepwise projection for solving the Lattice-LDA optimization problem is disclosed. The constraints gᵢ(β⁽ⁱ⁾)≥0 are shape constraints specifying the shape of each individual feature.

Adam is an SGD optimizer applied in various machine learning tools. The loss function may be denoted as L(β). At the t^{th} iteration, the standard gradient descent algorithm updates the iterate:

βₜ₊₁=βₜ−α∇L(βₜ)

where α is the learning rate and ∇L(βₜ) is the gradient of the loss function. Due to the randomness of the gradient estimation, instead of directly using the gradient, the Adam optimizer updates the first and second moments mₜ and vₜ using the following moving average approach:

mₜ₊₁←b₁mₜ+(1−b₁)∇L(βₜ)

vₜ₊₁←b₂vₜ+(1−b₂)(∇L(βₜ))²

where b₁ and b₂ are exponentially decaying rates.

The bias-corrected first and second moments are then estimated as follows:

$${\hat{m}}_{t + 1} = \frac{{m}_{t + 1}}{1 - {b}_{1}^{t + 1}}$$

$${\hat{v}}_{t + 1} = \frac{{v}_{t + 1}}{1 - {b}_{2}^{t + 1}} .$$

Finally, iterate βₜ₊₁ is updated using a dynamic learning rate:

$${β}_{t + 1} = {β}_{t} - α \frac{{\hat{m}}_{t + 1}}{\sqrt{{\hat{v}}_{t + 1} + ϵ}}$$

where ϵ is a stability control parameter and α is a predefined constant variable.

In order to satisfy the constraint gᵢ(β⁽ⁱ⁾)≥0, a shape projection algorithm is adopted at each iteration. The new iterate update step is expressed as follows:

$${β}_{t + 1} = proj ( {β}_{t} - α \frac{{\hat{m}}_{t + 1}}{\sqrt{{\hat{v}}_{t + 1} + ϵ}} ) , s . t . {g}_{i} ( {β}^{( i )} ) \geq 0$$

There are two basic types of projection algorithms for the monotone shapes and convex/concave shapes.

FIG. 4B illustrates an example of the projection of a monotone increasing shape type. To transform a shape constraint into a monotone increasing shape, consider a given vector β=(β₁, β₂, . . . , β_{K}) and compute the step difference between the values Δβₖ=βₖ₊₁−βₖ, k=1, 2, . . . , K−1. Then, convert the difference values to nonnegative (or nonpositive) and recalculate the vector based on the first value, \hat{β}=proj(β) where

$${\hat{β}}_{k} = {β}_{1} + {\sum }_{i = 1}^{k - 1} min / max ( Δ {β}_{i} , 0 ) ,$$

where “max” is indicative of the maximum and should be applied in monotone increasing types and “min” is indicative of the minimum and should be applied in monotone decreasing types.

The algorithm that projects a vector as convex (or concave) is based on Dykstra's alternating projections algorithm. In addition to the knot value difference Δβₖ, define the step difference of the knot locations as ΔXₖ=Xₖ₊₁−Xₖ, k=1, 2, . . . , K−1. The new \hat{β} is alternatively updated in a set of two steps:

$$Δ {\hat{β}}_{k} = min / max ( Δ {β}_{k} , \frac{Δ {X}_{k} ( Δ {β}_{k} + Δ {β}_{k + 1} )}{Δ {X}_{k} + Δ {X}_{k + 1}} ) , k = 1 , 3 , …$$

$$Δ {\hat{β}}_{k} = max / min ( Δ {β}_{k} , \frac{Δ {X}_{k + 1} ( Δ {β}_{k} + Δ {β}_{k + 1} )}{Δ {X}_{k} + Δ {X}_{k + 1}} ) , k = 2 , 4 , …$$

Use “min and max” for the convex type and “max and min” for the concave type. That way, the projection value becomes \hat{β}=proj(β) which is calculated using the following formula:

$${\hat{β}}_{k} = {β}_{1} + {\sum }_{i = 1}^{k - 1} Δ {\hat{β}}_{k} .$$

### Example Operations

Turning to FIGS. 11-14, example flowcharts are illustrated that contain example operations implemented by example embodiments described herein. The operations illustrated in FIGS. 11-14 may, for example, be performed by system device 104 of the Lattice-LDA system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, training circuitry 208, classifier circuitry 210, and/or any combination thereof. It will be understood that user interaction with the Lattice-LDA system 102 may occur directly via communications hardware 206, or may instead be facilitated by a separate user device (e.g., user devices 110A-110N), as shown in FIG. 1, and which may have similar or equivalent physical componentry facilitating such user interaction.

Turning first to FIG. 11, example operations are shown for training a Lattice-LDA analysis. As shown by operation 1102, the apparatus 200 includes means, such as communications hardware 206, or the like, for receiving a training dataset including one or more features. The one or more features may be characteristics of the training dataset, typically numerical values or characteristics that may be converted to numerical values. A given feature may be present for all of the training dataset, or may only be present for a subset of the training dataset, in the case where the training dataset is not complete. For example, a training dataset collected to track diabetes risk in a population may have features such as age, blood pressure, body mass index, or the like. The training dataset may have previously been stored in a storage device 104 as set forth in FIG. 1, which may comprise memory 204 of the apparatus 200 or a remote storage device 104 accessible by the apparatus 200 using communications hardware 206 or the like. In such cases, the training dataset may be retrieved by the apparatus 200 unilaterally. However, the training dataset may be received from a separate device with which a user interacts (e.g., one of user device 110A through user device 110N), in which case the training dataset may be received via communications hardware 206. If the user interacts directly with the apparatus 200, the training dataset may be received via attached input devices of the communications hardware 206. The training dataset may comprise a series of data points, where each data point has a value for each known feature in the training dataset.

As shown by operation 1104, the apparatus 200 includes means, such as communications hardware 206, training circuitry 208, or the like, for selecting a set of shape constraints. The set of shape constraints includes a shape constraint for each feature in the training dataset. The shape constraint may be a form of regularization applied to the Lattice-LDA model which restricts function values on the lattice to follow certain shape requirements such as monotonicity, convexity, or concavity. The Lattice-LDA model may ensure the shape constraints are satisfied by imposing restrictions on lattice function values in the optimization algorithm. Shape constraints may be imposed component-wise, or on individual features of the training dataset. For example, a training dataset with four features may have a different shape constraint applied to each feature, or may have certain features with no shape constraint at all, described by a linear model for the shape constraint.

As noted previously, training a Lattice-LDA utilizes shape constraint information for each feature. Accordingly, the set of shape constraints includes a shape constraint for each feature in the training dataset. The training circuitry 208 may select the set of shape constraints in any number of ways. For instance, the user may provide, via communications hardware 206 of the apparatus 200 (or by a separate client device, and then relayed to the apparatus 200 via communications hardware 206) input comprising a shape constraint selection for one or more of the features in the training dataset. Following receipt of any shape constraint selections, the training circuitry 208 may then select the set of shape constraints to include the shape constraint selections provided by the user. However, the user may not provide shape constraint selection for any of the features in the training dataset. In such situations, the apparatus 200 may utilize a trial-and-error approach to identify shape-constraint information for one or more of the features in the training dataset. To this end, the training circuitry 208 may initially identify a linear shape constraint for every feature in the training dataset. Subsequently, the training circuitry 208 may generate an approximation spline function for the various features in the training dataset using a monotone increasing or decreasing shape constraint selection. Where the approximation spline function for a given feature is a flat line (e.g., having a slope of zero), that indicates that the assigned shape constraint is not the correct shape-constraint for the given feature, and the training circuitry 208 then selects the other monotone shape constraint for that feature and generates a new approximation spline function for the feature. If the new approximation spline function for the feature does not comprise a flat line, the training circuitry 208 selects additional convex or concave shape constraint to the monotone shape constraint of the feature and generates another new approximation spline function for the feature. This iterative process may occur until a shape constraint is selected for the feature such that the approximation spline function does not produce a flat line, at which point the then-current shape constraint for the feature is selected and used for training of the Lattice-LDA. This process may be performed by the training circuitry 208 for each feature in the training dataset to select the set of shape constraints for the training dataset even in situations where there is no a priori knowledge of the shape constraints for the training dataset.

As shown by operation 1106, the apparatus 200 includes means, such as processor 202, memory 204, communications hardware 206, training circuitry 208, or the like, for training the Lattice-LDA using the training dataset and the selected set of shape constraints. The Lattice-LDA is generated based on an additive form of a plurality of nonlinear functions, and training the Lattice-LDA generates a shape-restricted hyperplane that defines a decision boundary separating a first class of data points in the training dataset from a second class of data points in the training dataset. LDA is the method developed by Ronald Fisher in 1936 which provides a solution to the classification problem by finding a linear combination of dataset features that separates two classes of a training dataset. Unlike the Lattice-LDA, the standard LDA is not able to utilize shape information to improve the model's prediction accuracy and interpretability. The lattice may be a regular set of points, in the space of a training dataset, or a subspace thereof. In the Lattice-LDA approach, points of the lattice are identified with knots, points on which interpolated parametric functions are fixed. The location of points on the lattice, and subsequently the locations of the knots, may be determined by a variety of methods. In some embodiments, user input may be interpreted to fix knots to particular locations. In some embodiments, knots may be automatically evenly spaced over the domain of a training dataset. The sub-intervals defined by dividing the training dataset domain by the knots are referred to as “buckets.” The term “knot value vector” refers to a vector of the knot values described above.

The hyperplane may be a set of points with dimensionality of one less than the dimensionality of the space in which the points are embedded. In LDA, a hyperplane defines the discriminant boundary between two classes of a training dataset. For example, a training dataset with two input features would exist in a two-dimensional plane, while the discriminant boundary would be defined by a one-dimensional line. In Lattice-LDA, a nonlinear function f(⋅) may define the hyperplane, which is defined as an additive form of 1-D nonlinear functions rᵢ(xᵢ) of each feature xᵢ:

$$f ( x ) = {\sum }_{i = 1}^{d} {r}_{i} ( {x}_{i} ) + {β}_{0}$$

In some embodiments, the set of shape constraints is selected from a set of candidate shape constraints. The set of candidate shape constraints includes a linear shape constraint, a monotone increasing shape constraint, a monotone decreasing shape constraint, a convex shape constraint, a concave shape constraint, and a combination of two or more of the above shape constraints. Example implementations of the shape constraints are given in detail above in connection with FIG. 4B, including example projection algorithms that may be applied during the SGD optimization. It will be appreciated by one of ordinary skill in the art that other shape constraints may be constructed and/or specified for the Lattice-LDA by combining several of the shape constraints listed above, or by modifying or generating additional projection algorithms that may be applied during the SGD optimization.

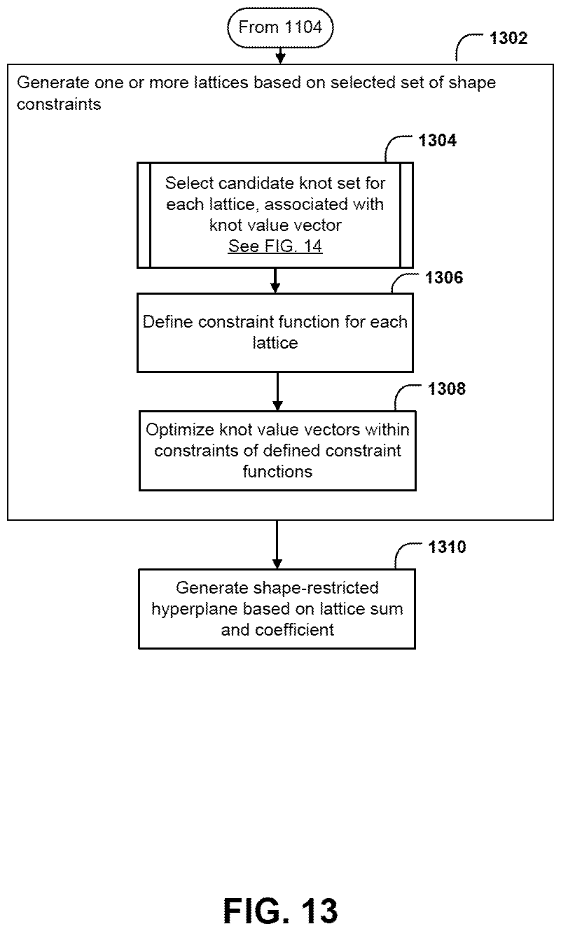

Training the Lattice-LDA has been described in great detail in previous sections and is addressed below in connection with FIG. 13.

Following training of a Lattice-LDA as set forth in operation 1106, the procedure may utilize the trained Lattice-LDA in any number of ways. To this end, the procedure may advance to one or more of operations 1108 or 1502, which are set forth below. Where the goal of the procedure is simply to train the Lattice-LDA, however, the procedure may end without advancing to any of these operations.

As shown by operation 1108, the apparatus 200 includes means, such as communications hardware 206, or the like, for outputting the trained Lattice-LDA. Outputting the trained Lattice-LDA may entail transmitting the nonlinear hyperplane produced during training of the Lattice-LDA. As with the receipt of the training dataset at the outset of the procedure set forth in FIG. 11, the manner of outputting of the trained Lattice-LDA may depend on whether the user interacts directly with the apparatus 200 or interacts with the apparatus 200 via a separate client device. In the former case, communications hardware 208 may output the trained Lattice-LDA via one or more attached output devices. In the latter case, the communications hardware 206 may output the trained Lattice-LDA by transmitting it to the separate user device.

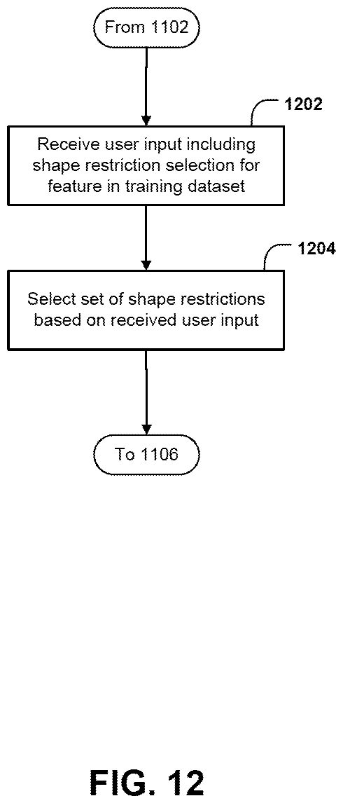

Turning next to FIG. 12, example operations are shown for determining and selecting the set of shape constraints. The flow of operations may progress to operation 1202, or may continue to operation 1106. In some embodiments, both operation paths may be followed, and the paths may be executed in parallel or otherwise simultaneously by the apparatus 200.

As shown by operation 1202, the apparatus 200 includes means, such as communications hardware 206, or the like, for receiving user input, including a shape constraint selection for a feature in the training dataset. To this end, the apparatus 200 may receive a shape constraint selection for a feature in the training dataset via communications hardware 206, following closely the method of receiving inputs in operation 1102, for example. While the operation 1202 describes receiving a shape constraint selection for a feature in the training dataset, it will be understood that the operation 1102 may be performed multiple times and a plurality of shape constraint selections may be received, and/or shape constraint selections for a plurality of features in the training dataset may be received.

As shown by operation 1204, the apparatus 200 includes means, such as processor 202, memory 204, communications hardware 206, training circuitry 208, or the like, for selecting the set of shape constraints based on the received user input. As described previously in connection with operation 1104, the training circuitry 208 may select the set of shape constraints based on user input, and in some instances, user input may specify all, some, or none of the shape constraints corresponding to each data feature. In an instance in which, shape constraint information is not provided by user input for one or more training dataset features, the apparatus 200 may utilize additional methods, such as a trial-and-error approach to identify shape constraint information for one or more of the features in the training dataset.

Turning next to FIG. 13, example operations are shown for preparing lattices and generating a hyperplane discriminant for the Lattice-LDA. As shown by operation 1302, the apparatus 200 includes means, such as training circuitry 208, or the like, for generating one or more lattices based on the selected set of shape constraints. Each lattice corresponds to one or more of the one or more features in the training dataset. The training circuitry 208 may generate the one or more lattices, described above as defined by sets of K knots, X_{1,i}≤X_{2,i}≤ . . . ≤X_{K}_{ᵢ}_{,i}, for a given feature i, using example operations 1304 through 1310.

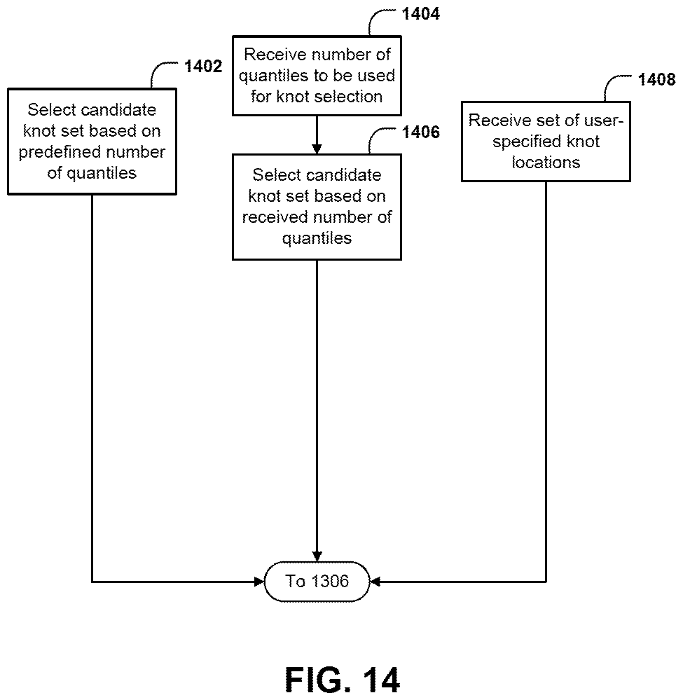

As shown by operation 1304, the apparatus 200 includes means, such as training circuitry 208, or the like, for selecting a candidate knot set for each lattice. The candidate knot set is associated with a knot value vector. The selection of candidate knot sets is described below in further detail in connection with FIG. 14, and the training circuitry 208 may select the candidate knot set and associated knot value vector β according to operations 1402 through 1408.

As shown by operation 1306, the apparatus 200 includes means, such as training circuitry 208, or the like, for defining, based on the selected set of shape constraints, a constraint function for each lattice. The constraint function for each lattice, written previously as gi(⋅)≥0, is a conceptual form of constraint that requires each knot value vector β(i) to satisfy the corresponding shape constraints (where i indexes each feature of the training dataset). The training circuitry 208 may the gi(⋅) functions in a number of ways depending on the type of shape constraint selected. In some embodiments, the projective algorithms described previously in connection with FIG. 4B may be utilized. In the case where a shape constraint for a particular training dataset feature is selected to have a linear shape constraint, the corresponding gi(⋅) function may be trivial and no shape constraint may be applied to the knot value vector. It will be understood that the example projective algorithms described previously only represent two example methods of defining shape constraints as constraint functions on the lattices, and other methods may be implemented or selected by users of the Lattice-LDA system 102.

As shown by operation 1308, the apparatus 200 includes means, such as training memory 204, circuitry 208, or the like, for optimizing each knot value vector within constraints of the defined constraint function for the corresponding lattice to find an optimized knot value vector. The optimization problem for the knot vector β(i) with shape constraints applied may be expressed in the compact form of the constrained optimization problem:

$$\overline{β} ∝ {arg min}_{β} S ( β )$$

subject to gᵢ(β⁽ⁱ⁾)≥0, i=d₁+1, . . . , d. The training circuitry 208 may use any number of techniques to solve this optimization problem. The training circuitry 208 may utilize additional circuitry, either components of the apparatus 200 or external to the apparatus 200 to solve the optimization problem and retrieve the output. Once solved, the optimization problem may yield the optimized knot value vector, \hat{β}. The optimized knot value vector \hat{β} may be stored in memory 204 or other storage, and used to compute the output of the Lattice-LDA model in operation 1310 and/or subsequent operations.

In some embodiments, optimizing each knot value vector includes utilizing an Adaptive Moment Estimation (Adam) stochastic gradient descent (SGD) algorithm. The Adam algorithm may be an SGD optimization algorithm applied in various machine learning tools. Denote the loss function as L(β). At the t^{th} iteration, the standard gradient descent algorithm updates the iterate:

βₜ₊₁=βₜ−α∇L(βₜ)

where α is the learning rate and ∇L(βₜ) is the gradient of the loss function. Due to the randomness of the gradient estimation, instead of directly using the gradient, the Adam optimizer updates the first and second moments mₜ and vₜ using the following moving average approach:

mₜ₊₁←b₁mₜ+(1−b₁)∇L(βₜ)

vₜ₊₁←b₂vₜ+(1−b₂)(∇L(βₜ))²

where b₁ and b₂ are exponentially decaying rates.

The bias-corrected first and second moments are then estimated as follows:

$${\hat{m}}_{t + 1} = \frac{{m}_{t + 1}}{1 - {b}_{1}^{t + 1}}$$

$${\hat{v}}_{t + 1} = \frac{{v}_{t + 1}}{1 - {b}_{2}^{t + 1}} .$$

Finally, iterate βₜ₊₁ is updated using a dynamic learning rate:

$${β}_{t + 1} = {β}_{t} - α \frac{{\hat{m}}_{t + 1}}{\sqrt{{\hat{v}}_{t + 1} + ϵ}}$$

where ϵ is a stability control parameter.

In some embodiments, the training circuitry 208 may apply a shape projection algorithm at each iteration of the SGD algorithm to satisfy the constraints of the constraint functions. The shape projection algorithm may be a step in the optimization method of Lattice-LDA where shape constraints are imposed on the knot value vector. The constraints gi(β(i))≥0 on the knot value vector β(i) are shape constraints specifying the shape of each individual feature. The shape projection algorithm is chosen for each shape constraint to impose the constraints at each step of the optimization method. The training circuitry 208 may apply the shape projection algorithm by directly modifying the knot value vector entries stored in memory 204 or other storage.

As shown by operation 1310, the apparatus 200 includes means, such as processor 202, memory 204, training circuitry 208, or the like, for combining the generated lattices and a coefficient to generate the shape-restricted hyperplane. As shown previously, in LDA, the separating hyperplane is linear:

$$f ( x ) = {x}^{T} β + {β}_{0} = {\sum }_{i = 1}^{d} {x}_{i} {β}_{i} + {β}_{0} = 0$$

where d is the number of features. The training circuitry may generate the shape-restricted hyperplane by the expression:

$$f ( x ) = {\sum }_{i = 1}^{d} {r}_{i} ( {x}_{i} ) + {β}_{0}$$

where each shape-restricted 1-D lattice rᵢ(xᵢ) is written in terms of the knot values β and the coefficient weight vector ϕ(x):

r(x)=ϕ(x)^{T}β

The training circuitry 208, in conjunction with processor 202, may use the optimized value of \hat{β}, the knot value vector, to compute the shape-restricted hyperplane as written above. The computation may allow the shape-restricted hyperplane to be expressed as a geometric object, stored in memory 204, or used to classify input data, as described in subsequent operations.

Turning next to FIG. 14, example operations are shown for selecting a candidate knot set. As shown by operation 1402, the apparatus 200 includes means, such as processor 202, memory 204, communications hardware 206, training circuitry 208, or the like, for selecting the candidate knot set based on the predefined number of quantiles. The candidate knot set can be selected in a number of ways. For instance, a specific number of quantiles may be predefined by the training circuitry 208 for use as candidate knots during the training process. Where no candidate knots are provided by user input, this predefined number of quantiles may then be utilized to generate the candidate knot set, as set forth previously. For instance, where the predefined number of quantiles is 10, the training circuitry 208 may select the candidate knots as points for the particular feature at percentile inputs in the training dataset in line with the predefined number of quantiles.

As shown by operation 1404, the apparatus 200 includes means, such as processor 202, memory 204, communications hardware 206, training circuitry 208, or the like, for receiving a number of quantiles to be used for knot selection. To this end, the apparatus 200 may receive a number of quantiles to be used for knot selection via communications hardware 206, following closely the method of receiving inputs in operation 1102, for example.

As shown by operation 1406, the apparatus 200 includes means, such as processor 202, memory 204, communications hardware 206, training circuitry 208, or the like, for selecting the candidate knot set based on the received number of quantiles. Another way to select the candidate knot set is via user input may of a particular number of quantiles to be utilized to generate the candidate knot set. In this fashion, rather than defaulting to the predefined number of knots set by the training circuitry 208, the user may select a desired number of knots to use for the candidate knot set. However, the process for identifying the candidate knots for candidate knot set remains the same as when using the predefined number of quantiles, except that the training circuitry 208 selects the candidate knots as points for the particular feature at percentile inputs in line with the user input.

As shown by operation 1408, the apparatus 200 includes means, such as processor 202, memory 204, communications hardware 206, training circuitry 208, or the like, for receiving a set of user-defined knot locations, where the candidate knot set includes the set of user-defined knot locations. Still another way to select the candidate knot set is via user input of knot locations. To this end, the user may submit (and the apparatus 200 may receive, via communications hardware 206, as appropriate), a set of user-specified knot locations. Subsequently, the training circuitry 208 simply utilizes the user-specified knot locations as the candidate knots during the training procedure.

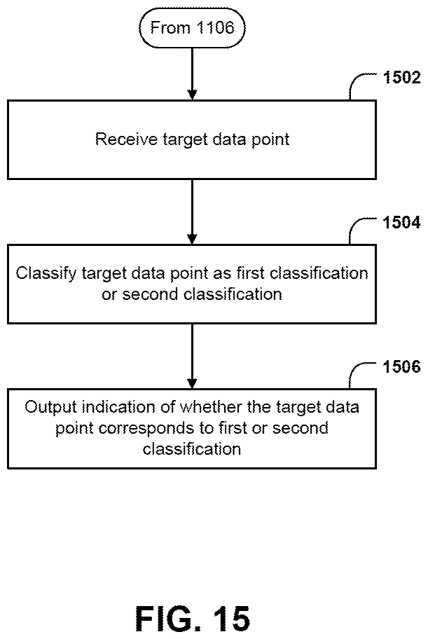

Turning next to FIG. 15, example operations are shown for classifying a data point using the trained Lattice-LDA. As shown by operation 1502, the apparatus 200 includes means, such as communications hardware 206, or the like, for receiving a target data point. To this end, the apparatus 200 may receive a target data point for classification via communications hardware 206, following closely the method of receiving inputs in operation 1102, for example.

As shown by operation 1504, the apparatus 200 includes means, such as classifier circuitry 208, or the like, for classifying, by using the trained Lattice-LDA, the target data point as a first classification or a second classification. Following receipt of the target data point, the classifier circuitry 210 of the apparatus 200 may use the trained Lattice-LDA to classify the target data point into a first classification or a second classification. To do this, the nonlinear hyperplane produced by training the Lattice-LDA may be used to determine the classification of the data point.

Finally, as shown by operation 1506, the apparatus 200 includes means, such as communications hardware 206, or the like, for outputting an indication of whether the target data point corresponds to the first classification or the second classification. The communications hardware 206 may output or otherwise return an indication of whether the target data point is in the first classification or the second classification. Of course, although operations 1502 through 1506 describe classifying a single data point, it will be understood that operations 1502 through 1506 may be utilized any number of times to classify any number of data points.

As described above, example embodiments provide methods and apparatuses that enable improved training of LDA using shape data from the training dataset. Example embodiments thus improve accuracy over standard LDA by incorporating shape information, and can limit problems such as overfitting by regularizing the model response. Example embodiments directly support shape constraints such as monotonicity and convexity/concavity, and also support more complex shapes through combinations of simpler shape constraints. The use of the Adam SGD algorithm, modified to take into account the shape constraints, efficiently trains the Lattice-LDA model, and demonstrates comparable or better performance than similar models that do not account for shape information.

As these examples all illustrate, example embodiments contemplated herein provide technical solutions that solve real-world problems faced solving classification problems. While the classification problem has a long history of development and a variety of solutions for particular problems, the prevalence of datasets with underlying shape restricted relationships and the increased demand to classify these datasets efficiently and accurately motivates the development of the Lattice-LDA solution. Financial problems, for example, with monotonic price functions or concave risk functions are examples of real-world problems where knowledge of underlying shape information may improve the modelling of a dataset to solve a particular business need.

FIGS. 11-15 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### EXAMPLE SIMULATIONS

### Example 1

The performance of the Lattice-LDA classifier was assessed using three simulation examples. In particular, the model's ability to recover underlying marginal effect functions and the model goodness of fit was evaluated. For illustration purposes, the target attribute y comprises two labels {−1,1}. The marginal effect functions, or the responses of y to each input variable x, are subject to shape constraints.

Table 2 summarizes the simulation settings and the Lattice-LDA model hyperparameters in the three examples. Nineteen equally-spaced percentiles from 0.05 to 0.95 and two minimum and maximum points were used as the knot set for each feature.

TABLE 2
Simulation Settings

| | | | | Shape | Shape |
|---|---|---|---|---|---|
| # | n | X distribution | r(x) | Type | Label |
| 1 | 5,000 | x₁~Unif(0, 1) | NA | Linear | 1 |
| | | x₂~Unif(0, 1) | NA | Concave | ccv |
| 2 | 5,000 | x₁~Unif | x₁³ | S-shape | ccv, |
| | | (−0.5, 0.5) | | | cvx |
| 3 | 5,000 | x₁~Unif | 2x₁² | convex | cvx |
| | | (−0.5, 0.5) | | | |
| | | x₂~Unif(0, 1) | exp(x₂)-1 | convex | cvx |
| | | x₃~Unif(0, 1) | log(x₃)/4 + 2 | convex | ccv |

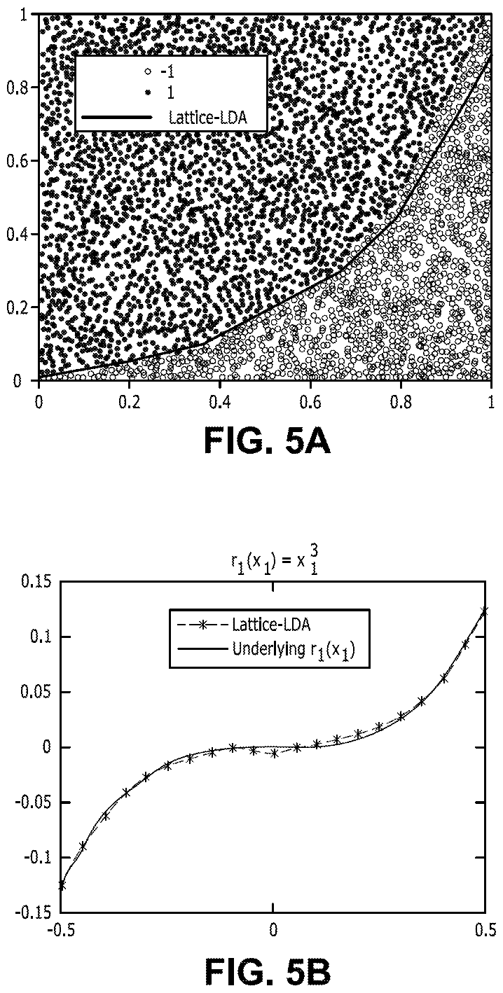

The first example (#1) is directed to a convex increasing function. The first experiment is a 2-D example in a box domain. Both x1 and x2 are sampled from the standard uniform distribution in (0, 1). We then separate the data into two groups by a convex increasing curve, as shown in FIG. 5A. Although the underlying curve is “convex increasing”, the shape constraints in the model are indicated as x1 equal to “1” (e.g., linear) and x2 equal to “ccv” (e.g., concave). FIG. 5A also plots the reconstructed piecewise linear discriminant curve, a convex piecewise linear function. As observed, the approximation of the underlying nonparametric curve is precise in the interval (0.2, 0.8), where the samples are dense, but less accurate than the edges of the x domain.

The second example (#2) is directed to a concave to convex S-shape. The second example is a 1-D example with x₁ generated from a uniform distribution in (−0.5,0.5). Here, y is from a binomial distribution with the probability p to be an S-shape function of

p=r₁(x₁)=x₁³.

The value p is also normalized to the range (0,1). In order to handle the S-shape function, x₁ is broken into two additive components, where

x_{1,pos}=max(x₁, 0), and x_{1,neg}=min(x₁, 0).

As such, the probability p can be expressed as:

p=r₁(x₁)=r_{1,pos}(x_{1,pos})+r_{1,neg}(x_{1,neg}).

Both the new functions r_{1,pos} and r_{1,pos} are modeled in Lattice-LDA, and the specified shapes for the x_{1,pos} and x_{1,neg} are “ccv” (e.g., concave) and “cvx” (e.g., convex). FIG. 5B shows the combined piecewise linear approximation result, where two curve components are scaled and concatenated. It can be observed that the Lattice-LDA is able to approximate the actual functional form r₁(x₁)=x₁³ precisely.

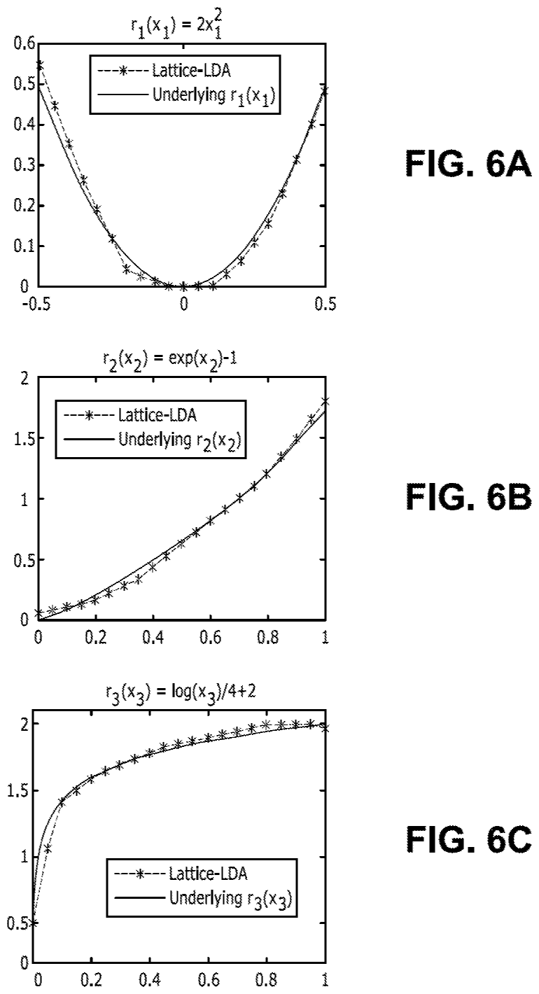

The third example (#3) is an additive model. A 3-D example is generated with x₁, x₂, and x₃ from the uniform distributions described in Table 2. The probability p to generate the binary response y is defined by an addition model p=Σⱼ₌₁³rⱼ(xⱼ), where the underlying functions are r₁(x₁)=2x₁², r₂(x₂)=exp(x₂)−1, and r₃(x₃)=log(x₃)/4+2. Similar to the previous experiment, the vector pᵢ is standardized so that the range is (0, 1). The specified shapes for x₁, x₂, and x₃ according to the underlying functions are “cvx” (e.g., convex), “cvx” (e.g., convex), and “ccv” (e.g., concave), respectively. FIGS. 6A, 6B, and 6C depict the reconstructed piecewise linear functions for the three features. The model fitted curve is scaled for each feature to have the same range as the actual functions. Based on the results, it is shown that the Lattice-LDA approximates the two convex functions well. For the concave function r₃(x₃), the approximation is slightly less accurate when in the interval x₃<0.1, this is due to the fact that the knots are spare in that data range.

In the three examples, Lattice-LDA can recover the underlying parametric or nonparametric functions with high accuracy, yielding better classification than conventional linear classifier. It is noted that increasing the sample size or using more dense selection of knots would improve the goodness of model fit, but it would also require the optimization process to take a longer time (and more iterations), which may cause overfitting in the data. The simulations indicate that between 10 to 20 candidate knots are sufficient for the algorithm to maintain the classification accuracy.

### Example 2

The performance of the Lattice-LDA was compared with a set of classifiers using several real examples. The classification accuracy is evaluated by comparing Lattice-LDA with the following classifiers: standard LDA, SVM (Gaussian kernel), Classification tree, Classification tree using Adaptive Boosting, and PM-SVM. The approximation functions of each feature are also recovered to improve the understanding of the underlying relationship between outputs and features. Note that in the real examples, a PM-SVM method is applied with a Randomised Conjunctive (CJ1) algorithm to generate the constraint set. The datasets were obtained from the UCI Machine Learning Repository. Table 3 describes the summarized statistics of the data and all entries with missing values were removed.

TABLE 3
Description of data set

| Data Set | # Obs | # Features | # Original Classes | Source |
|---|---|---|---|---|
| Pima | 768 | 8 | 2 | UCI |
| Wisc Breast | 683 | 9 | 2 | UCI |
| Cancer (WBC) | | | | |

A 10-fold cross-validations were applied on each dataset, where each run used a random 90% source data as training sample, and the remaining 10% data was used as test sample. The same training/test partitions were used for all the classifiers to ensure a fair comparison. The performance measure being used is the average accuracy, which equals one minus the mean of mis-classification rate of 0/1 loss computed based on the 10-fold cross-validation. Table 4 describes the results, including the average accuracy and the standard deviation. Note that for the classification tree method with Adaptive Boosting, 100 learning cycles were implemented in each training dataset.

TABLE 4
Classification performance in terms of average
accuracy and standard deviation of 0/1 loss.

| | | | SVM | | Tree | |
|---|---|---|---|---|---|---|
| Data Set | Lattice-LDA | LDA | (Gaussian) | Tree | (AdaBoost) | PM-SVM |
| Pima | 0.7748 | 0.7721 | 0.6707 | 0.7058 | 0.7566 | 0.7748 |
| | ±0.0488 | ±0.0369 | ±0.0579 | ±0.0460 | ±0.0488 | ±0.0428 |
| WBC | 0.9693 | 0.9590 | 0.9664 | 0.9267 | 0.9605 | 0.9605 |
| | ±0.0262 | ±0.0299 | ±0.0257 | ±0.0354 | ±0.0217 | ±0.0256 |

As shown in Table 4, the Lattice-LDA has better performance than all the other classification methods regarding the average accuracy results. In addition, it was observed that the Lattice-LDA not only has a better prediction accuracy than the standard LDA and SVM (including PM-SVM), but also more precise than the tree methods, which are known as typical nonlinear classifiers.

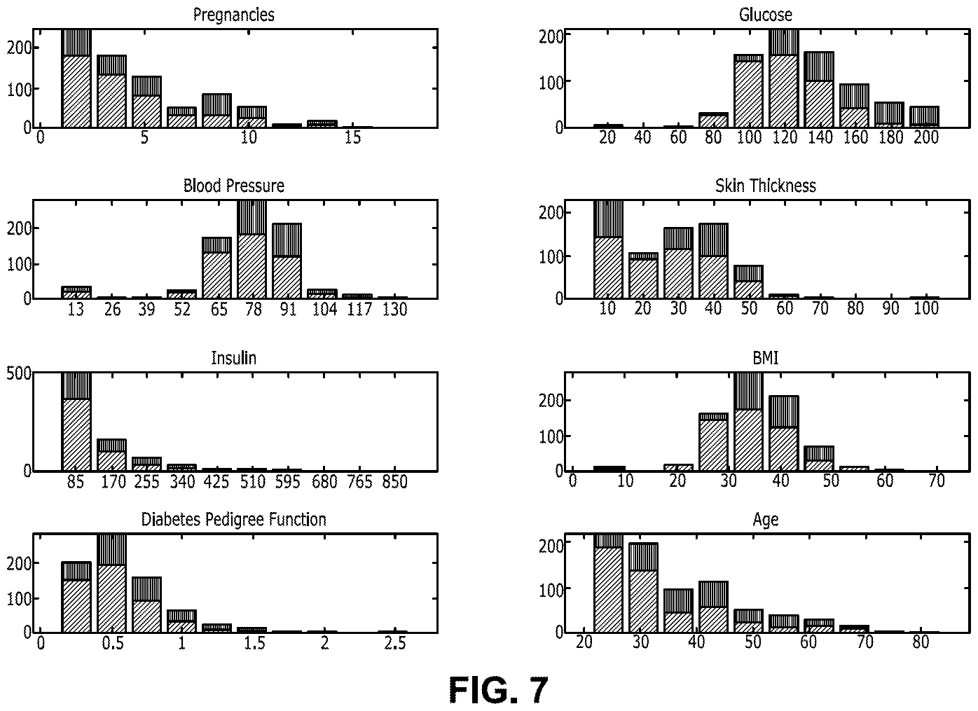

FIG. 7 shows the bar charts of all eight features in the Pima (Pima Indians Diabetes) example. The graphs in FIG. 7 have been assigned 1 (e.g., solid bar) to the decision attribute “class=test positive”, and −1 (e.g., slashed line bar) to “class=test positive”. Overall, about 35% of the patients tested positive to diabetes. Each feature was broken into 10 equal width buckets, and the bucket numbers shown in the figure present the right end point of the bucket.

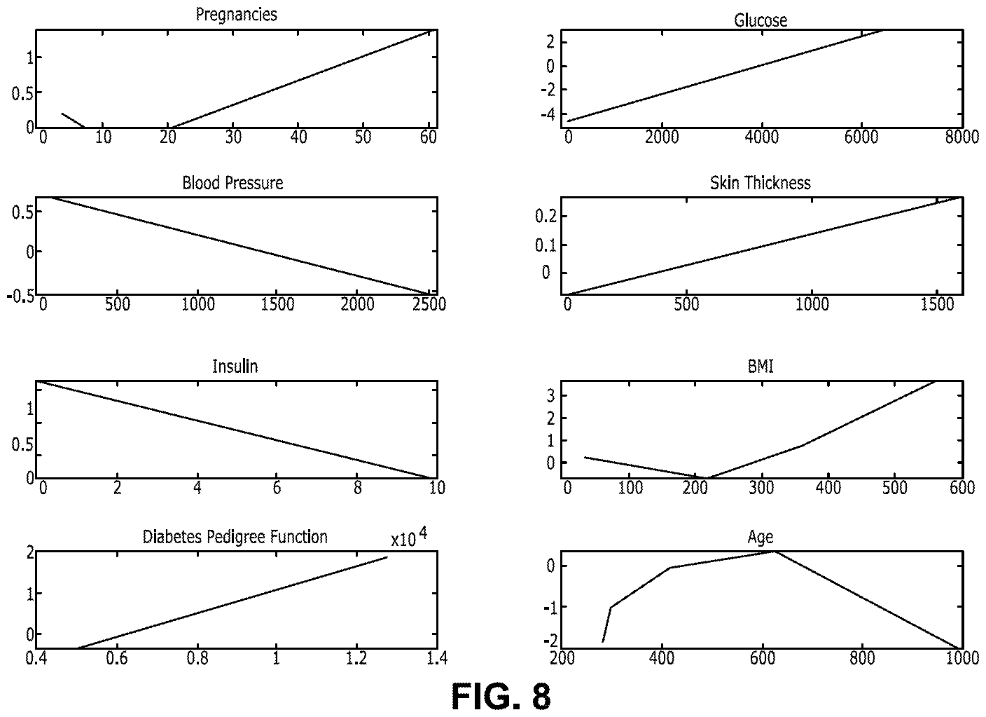

FIG. 8 shows the marginal shape approximation functions rᵢ(xᵢ) in the Pima data based on the proposed Lattice-LDA. As shown in FIG. 8, pregnancies and BMI have convex shapes; glucose, skin thickness and diabetes pedigree function have linear increasing shapes; and blood pressure and insulin have linear decreasing shapes, which are consistent with the trend in the bar charts. One interesting feature is age, which exhibits a concave shape, which is due to the fact that the majority of the data is associated with an age of 70 or less, and the Lattice-LDA methodology is affected more by outliers in the dataset.

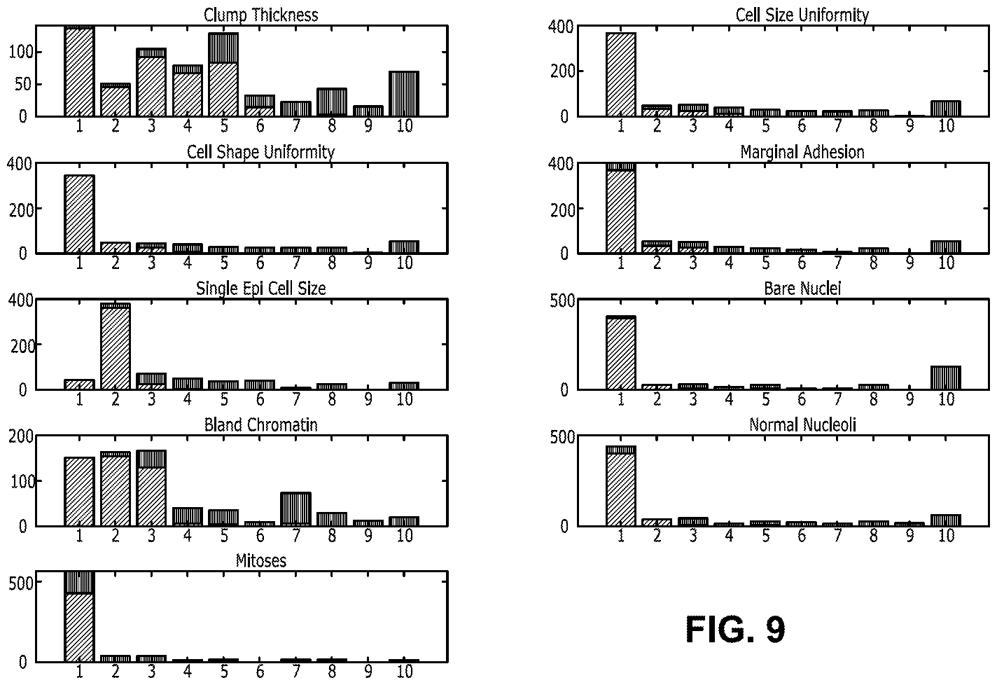

For the second example, FIG. 9 shows the bar charts of all nine features in the Wisconsin Breast Cancer (WBC) results. The graphs in FIG. 9 have been assigned 1 (e.g., solid bar) to the decision attribute “class=malignant” and −1 (e.g., slashed line bar) to “class=benign”. Overall, around 35% of the attributes are assigned “1”.

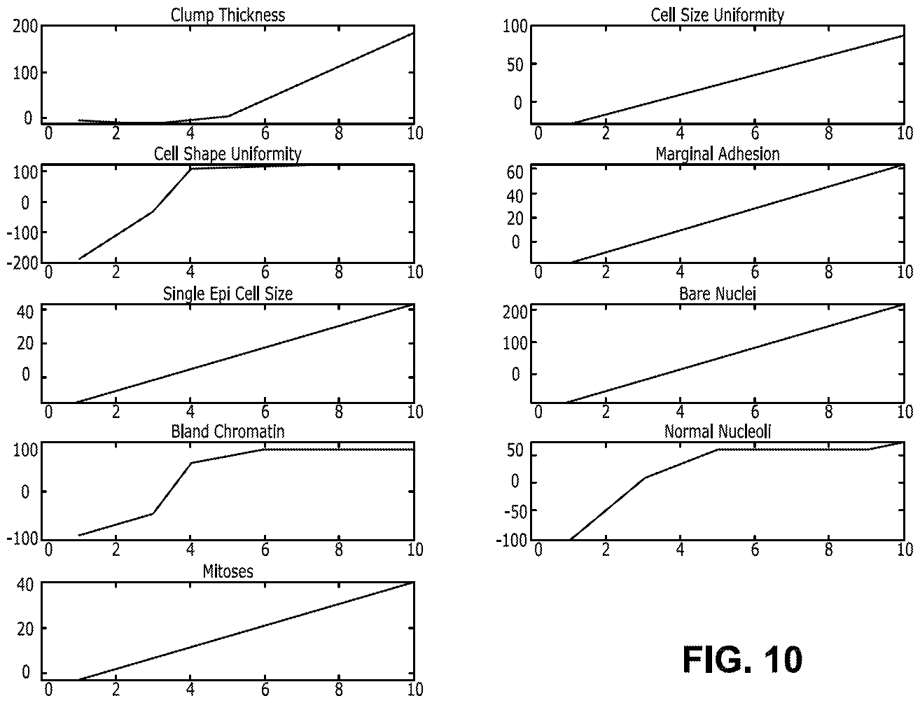

FIG. 10 shows the marginal shape approximation functions rᵢ(xᵢ) in the WBC example using Lattice-LDA. According to the results, all features reflect a monotone increasing or convex shapes, which is consistent with the trend in the bar charts. More specifically, clump thickness has a convex shape, whereas cell shape uniformity, bland chromatin and normal nucleoli reflect increasing shapes. The rest of the features all consist of linear increasing shapes.

From the real data analysis, one would note another advantage of the Lattice-LDA, is model interpretability. Since the proposed model accommodates the nonlinear relationship among the independent features, evaluating the monotonicity and convexity/concavity of the features is intuitive and may be performed simply by checking the fitted marginal effect function rᵢ(xᵢ). According to the results in the WBC example as shown in FIG. 10, the cell shape uniformity feature not only shows an increasing trend, but also produces a steeper effect when the value is between three and four than the less than three region and shows more flattened effect when the value is greater than four.

In addition, the pattern of specific features can be better fit by using more knots. However, increasing the number of knots would require more computational resources, and may cause an overfitting issue to the data. Based on the simulations, 10 to 20 candidate knots are sufficient for the algorithm to maintain the classification accuracy.

Overall, both the simulation and real data analysis support our idea that, adapting prior knowledge including shape information, into the classifiers could help to improve the model's prediction accuracy and give better insights to interpret the input features.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for training a lattice linear discriminant analysis model (Lattice-LDA), the method comprising:
receiving, by communications hardware, a training dataset comprising one or more features;
selecting, by training circuitry, a set of shape constraints, the set of shape constraints including a shape constraint for each feature in the training dataset; and
training, by the training circuitry, the Lattice-LDA using the training dataset and the selected set of shape constraints, wherein:
the Lattice-LDA is generated based on an additive form of a plurality of nonlinear functions, and
training the Lattice-LDA generates a shape-restricted hyperplane that defines a decision boundary separating a first class of data points in the training dataset from a second class of data points in the training dataset.

2. The method of claim 1, wherein selecting the set of shape constraints comprises:
receiving, by the communications hardware, user input comprising a shape constraint selection for a feature in the training dataset; and
selecting, by the training circuitry, the set of shape constraints based on the received user input.

3. The method of claim 1, wherein the set of shape constraints is selected from a set of candidate shape constraints, the set of candidate shape constraints comprising:
a linear shape constraint,
a monotone increasing shape constraint,
a monotone decreasing shape constraint,
a convex shape constraint,
a concave shape constraint, and
a combination of two or more of the above.

4. The method of claim 1, wherein training the Lattice-LDA includes:
generating, by the training circuitry, one or more lattices based on the selected set of shape constraints, wherein each lattice corresponds to one or more of the one or more features in the training dataset, wherein the Lattice-LDA comprises the generated lattices; and
combining, by the training circuitry, the generated lattices to generate the shape-restricted hyperplane.

5. The method of claim 4, wherein generating the one or more lattices includes:
selecting, by the training circuitry, a candidate knot set for each lattice, wherein the candidate knot set is associated with a knot value vector;
defining, by the training circuitry and based on the selected set of shape constraints, a constraint function for each lattice; and
optimizing, by the training circuitry, each knot value vector within constraints of the defined constraint function for the corresponding lattice to obtain an optimized knot value vector.

6. The method of claim 5, wherein selecting the candidate knot set includes:
identifying, by the training circuitry, a predefined number of quantiles; and
selecting, by the training circuitry, the candidate knot set based on the predefined number of quantiles.

7. The method of claim 5, wherein selecting the candidate knot set includes:
receiving, by communications hardware, a number of quantiles to be used for knot selection; and
selecting, by the training circuitry, the candidate knot set based on the received number of quantiles.

8. The method of claim 5, wherein selecting the candidate knot set includes:
receiving, by the communications hardware, a set of user-specified knot locations, wherein the candidate knot set comprises the set of user-specified knot locations.

9. The method of claim 5, wherein optimizing each knot value vector comprises utilizing an Adaptive Moment Estimation (Adam) stochastic gradient descent algorithm.

10. The method of claim 9, further comprising:
applying, by the training circuitry, a shape projection algorithm at each iteration of the stochastic gradient descent algorithm to satisfy the constraints of the constraint functions.

11. The method of claim 1, further comprising outputting, by the communications hardware, the trained Lattice-LDA.

12. The method of claim 1, further comprising:
receiving, by the communications hardware, a target data point;
classifying, by a classifier circuitry and by using the trained Lattice-LDA, the target data point as a first classification or a second classification; and
outputting, by the communications hardware, an indication of whether the target data point corresponds to the first classification or the second classification.

13. An apparatus for training a Lattice-LDA, the apparatus comprising:
communications hardware configured to:
receive a training dataset comprising one or more features; and
training circuitry configured to:
select a set of shape constraints, the set of shape constraints including a shape constraint for each feature in the training dataset, and
train the Lattice-LDA using the training dataset and the selected set of shape constraints, wherein:
the Lattice-LDA is generated based on an additive form of a plurality of nonlinear functions, and
training the Lattice-LDA generates a shape-restricted hyperplane that defines a decision boundary separating a first class of data points in the training dataset from a second class of data points in the training dataset.

14. The apparatus of claim 13, wherein the training circuitry is further configured such that selecting the set of shape constraints comprises:
receiving, by the communications hardware, user input comprising a shape constraint selection for a feature in the training dataset; and
selecting the set of shape constraints based on the received user input.

15. The apparatus of claim 13, wherein the set of shape constraints is selected from a set of candidate shape constraints, the set of candidate shape constraints comprising:
a linear shape constraint,
a monotone increasing shape constraint,
a monotone decreasing shape constraint,
a convex shape constraint,
a concave shape constraint, and
a combination of two or more of the above.

16. The apparatus of claim 13, wherein the training circuitry is further configured such that training the Lattice-LDA includes:
generating one or more lattices based on the selected set of shape constraints, wherein each lattice corresponds to one or more of the one or more features in the training dataset, wherein the Lattice-LDA comprises the generated lattices; and
combining, by the training circuitry, the generated lattices to generate the shape-restricted hyperplane.

17. The apparatus of claim 16, wherein the training circuitry is further configured such that generating the one or more lattices includes:
selecting a candidate knot set for each lattice, wherein the candidate knot set is associated with a knot value vector;
defining, based on the selected set of shape constraints, a constraint function for each lattice; and
optimizing each knot value vector within constraints of the defined constraint function for the corresponding lattice to obtain an optimized knot value vector.

18. The apparatus of claim 17, wherein the training circuitry is further configured such that selecting the candidate knot set includes:
identifying a predefined number of quantiles; and
selecting the candidate knot set based on the predefined number of quantiles.

19. The apparatus of claim 17, wherein the training circuitry is further configured such that selecting the candidate knot set includes:
receiving, by communications hardware, a number of quantiles to be used for knot selection; and
selecting the candidate knot set based on the received number of quantiles.

20. A computer program product for training a Lattice-LDA, the computer program product comprising at least one non-transitory computer-readable storage medium storing software instructions that, when executed, cause an apparatus to:
receive a training dataset comprising one or more features;
select a set of shape constraints, the set of shape constraints including a shape constraint for each feature in the training dataset; and
train the Lattice-LDA using the training dataset and the selected set of shape constraints, wherein:
the Lattice-LDA is generated based on an additive form of a plurality of nonlinear functions, and
training the Lattice-LDA generates a shape-restricted hyperplane that defines a decision boundary separating a first class of data points in the training dataset from a second class of data points in the training dataset.
